(19) United States
(12) Patent Application Publication
(10) Pub. No.: US 2016/0060422 A1
(43) Pub. Date: Mar. 3, 2016

(54) POLYMER PARTICLES ADSORBED TO SULFATE-PROCESS TITANIUM DIOXIDE

(71) Applicants: James BOHLING, Lansdale, PA (US); Junyu CHEN, Shanghai (CN); Wei CUI, Shanghai (CN); Juan LI, Shanghai (CN); Tao WANG, Shanghai (CN)

(72) Inventors: James C. Bohling, Lansdale, PA (US); Junyu Chen, Shanghai (CN); Wei Cui, Shanghai (CN); Juan Li, (US); Tao Wang, Highton (AU)

(21) Appl. No.: 14/784,307

(22) PCT Filed: Apr. 15, 2013
(86) PCT No.: PCT/CN2013/074189

§ 371 Date: Oct. 14, 2015

(51) Int. Cl. C08K 3/22

(52) U.S. Cl. CPC C08K 3/22; C08K 2003/2241

(57) ABSTRACT

Provided is an aqueous dispersion of particles of sulfate-process titanium dioxide, wherein polymeric particles are adsorbed onto said particles of titanium dioxide, wherein said polymeric particles comprise polymerized units of one or more P-acid monomer.

Also provided is an aqueous dispersion,
wherein said aqueous dispersion is a grind made by a process comprising making a mixture that comprises water, polymeric particles, and particles of sulfate-process titanium dioxide,
wherein said polymeric particles comprise polymerized units of one or more P-acid monomer, and
   wherein the volume ratio of said polymeric particles to said particles of sulfate-process titanium dioxide is 2.5:1 to 10:1.

There are two commercial processes for the manufacture of titanium dioxide particles, which are widely used as pigments in coatings and other products. The two processes are known as the sulfate process and the chloride process. The sulfate process may be used in the production of either of the crystal forms anatase titanium dioxide and rutile titanium dioxide; the chloride process typically is used only in the production of rutile titanium dioxide. In the sulfate process, ore that contains titanium is dissolved in sulfuric acid to produce a solution that contains titanium sulfate and other metal sulfates, including iron sulfate. Further steps include, for example, a crystallization step, during which iron sulfate is partially or fully separated from the production stream, and then precipitation and calcination steps to produce intermediate titanium dioxide. Further subsequent steps usually include, for example finishing steps that may include coating with an inorganic oxide layer and/or milling to de-agglomerate and reduce the size of the titanium dioxide particles.

It has been learned that coatings produced using sulfate-process titanium dioxide tend to have a more yellow appearance than coatings produced using chloride-process titanium dioxide, and such yellowness is undesirable. It is desired to provide materials and/or methods that allow the use of sulfate-process titanium dioxide and that reduce this tendency toward yellowness.

U.S. Pat. No. 6,080,802 describes titanium dioxide particles that are dispersed in an aqueous medium with a polymeric latex which adsorbs to the surface of the titanium dioxide. U.S. Pat. No. 6,080,802 does not discuss sulfate-process titanium dioxide or the associated tendency toward yellowness in coatings.

The following is a statement of the invention.

A first aspect of the present invention is an aqueous dispersion of particles of sulfate-process titanium dioxide, wherein polymeric particles are adsorbed onto said particles of titanium dioxide, wherein said polymeric particles comprise polymerized units of one or more P-acid monomer.

A second aspect of the present invention is an aqueous dispersion, wherein said aqueous dispersion is a grind made by a process comprising making a mixture that comprises water, polymeric particles, and particles of sulfate-process titanium dioxide, wherein said polymeric particles comprise polymerized units of one or more P-acid monomer, and wherein the volume ratio of said polymeric particles to said particles of sulfate-process titanium dioxide is 2.5:1 to 10:1.

The following is a detailed description of the invention.

As used herein, the following terms have the designated definitions, unless the context clearly indicates otherwise.

As used herein, a composition is a dispersion when discrete particles are distributed throughout a continuous liquid medium. The continuous medium is an aqueous medium if the continuous medium contains 50% or more water, by weight based on the weight of the medium. When the continuous medium is an aqueous medium, the dispersion is an aqueous dispersion.

Sulfate-process titanium dioxide is titanium dioxide that has been produced using the sulfate process described herein above.

A “polymer,” as used herein, is a relatively large molecule made up of the reaction products of smaller chemical repeat units. Polymers may have structures that are linear, branched, star shaped, looped, hyperbranched, crosslinked, or a combination thereof; polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof.

Polymer molecular weights can be measured by standard methods such as, for example, size exclusion chromatography (SEC, also called gel permeation chromatography or GPC). Polymers have weight-average molecular weight (Mw) of 1000 or more. Polymers may have extremely high Mw; some polymers have Mw above 1,000,000; typical polymers have Mw of 1,000,000 or less. Some polymers are crosslinked, and crosslinked polymers are considered to have infinite Mw.

The glass transition temperature of a polymer is measured by differential scanning calorimetry using the midpoint method.

As used herein “weight of polymer” means the dry weight of polymer.

Molecules that can react with each other to form the repeat units of a polymer are known herein as “monomers.” The repeat units so formed are known herein as “polymerized units” of the monomer.

Vinyl monomers have the structure (I)

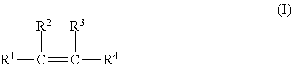

where each of R¹, R², R³, and R⁴ is, independently, a hydrogen, a halogen, an aliphatic group (such as, for example, an alkyl group), a substituted aliphatic group, an aryl group, a substituted aryl group, another substituted or unsubstituted organic group, or any combination thereof.

Vinyl monomers include, for example, styrene, substituted styrenes, dienes, ethylene, other alkenes, dienes, ethylene derivatives, and mixtures thereof. Ethylene derivatives include, for example, unsubstituted or substituted versions of the following: ethenyl esters of substituted or unsubstituted alkanoic acids (including, for example, vinyl acetate and vinyl neodecanoate), acrylonitrile, (meth)acrylic acids, (meth)acrylates, (meth)acrylamides, vinyl chloride, halogenated alkenes, and mixtures thereof. As used herein, “(meth)acrylic” means acrylic or methacrylic; “(meth)acrylate” means acrylate or methacrylate; and “(meth)acrylamide” means acrylamide or methacrylamide. “Substituted” means having at least one attached chemical group such as, for example, alkyl group, alkenyl group, vinyl group, hydroxyl group, carboxylic acid group, other functional groups, and combinations thereof. In some embodiments, substituted monomers include, for example, monomers with more than one carbon-carbon double bond, monomers with hydroxyl groups, monomers with other functional groups, and monomers with combinations of functional groups. (Meth)acrylates are substituted and unsubstituted esters or amides of (meth)acrylic acid.

As used herein, acrylic monomers are monomers selected from (meth)acrylic acid, alkyl esters of (meth)acrylic acid, alkyl esters of (meth)acrylic acid having one or more substituent on the alkyl group, (meth)acrylamide, N-substituted (meth)acrylamides, and mixtures thereof. As used herein, vinylaromatic monomers are monomers selected from styrene, alpha-alkyl styrenes, and mixtures thereof.

A vinyl-containing alcohol is a compound that has a polymerizable vinyl group (a vinyl group capable of participating in free-radical polymerization) and that has a pendant hydroxyl group.

A P-acid monomer is a phosphorus-containing acid monomer that contains at least one ethylenic unsaturation and a phosphorus acid group. The phosphorus acid monomer may be in the acid form or as a salt of the phosphorus acid groups.

A phosphoric acid monoester of a vinyl-containing alcohol has structure (II)

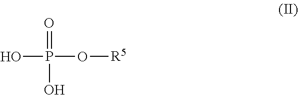

where R5 is an organic group that contains a polymerizable vinyl group.

An acid-functional monomer is a monomer has one or more acidic group, and at least one of the acidic groups remains intact after polymerization. A carboxyl-functional monomer is a monomer has one or more carboxyl group, and at least one of the carboxyl groups remains intact after polymerization.

As used herein, an “acrylic” polymer is a polymer in which 10% or more of the polymerized units are selected from acrylic monomers and also in which 75% or more of the polymerized units are selected from the group consisting of acrylic monomers, ethenyl esters of substituted or unsubstituted alkanoic acids, and vinylaromatic monomers, and mixtures thereof; the percentages are by weight based on the weight of the polymer.

Emulsion polymerization is a process of forming a polymer that involves the use of monomer emulsions, which are dispersions of liquid monomer particles in an aqueous medium. The monomer emulsion is normally stabilized with one or more surfactant and/or one or more water-soluble polymer. Typically, a water-soluble initiator is used. Polymer particles form in the continuous medium apart from the monomer emulsion particles. The resulting polymer particles are known as latex particles, and the resulting dispersion of polymer latex particles is known as a latex.

Polymer particles are said to be adsorbed onto titanium dioxide particles if a plurality of polymer particles are located on the surface of one or more titanium dioxide particles.

A binder polymer is a polymer that is present in a coating formulation. When the coating formulation is applied to a substrate surface, the binder polymer forms a continuous film that adheres to the surface and that holds other ingredients of the formulation (such as, for example, pigment particles) in place. Binder polymers have Tg of 30° C. or lower.

A coalescent is an organic compound used in aqueous coating formulations. A coalescent is capable of absorbing into particles of a binder polymer, effectively reducing the Tg of the polymer, thus allowing particles of the polymer to coalesce after the coating formulation has been applied to a substrate surface.

When a ratio is said herein to be X:1 or greater, it is meant that the ratio is Y:1, where Y is greater than or equal to X. For example, if a ratio is said to be 3:1 or greater, that ratio may be 3:1 or 5:1 or 100:1 but may not be 2:1. Similarly, when ratio is said herein to be W:1 or less, it is meant that the ratio is Z:1, where Z is less than or equal to W. For example, if a ratio is said to be 15:1 or less, that ratio may be 15:1 or 10:1 or 0.1:1 but may not be 20:1.

The present invention involves the use of polymeric particles that contain a polymer (“polymer (P)”). Polymer (P) contains polymerized units of one or more monomer (“monomer (M1)”) that is a P-acid monomer. Examples of phosphorus acid monomers include:

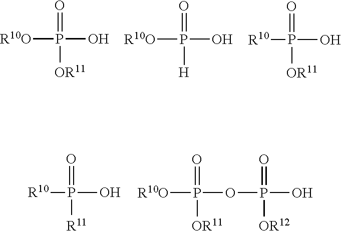

where R¹⁰ is an organic group containing an acryloxy, methacryloxy, or a vinyl group; and R¹¹ and R¹² are independently selected from H and a second organic group. The second organic group may be saturated or unsaturated.

Suitable phosphorus acid monomers include dihydrogen phosphate-functional monomers such as dihydrogen phosphate esters of an alcohol in which the alcohol also contains a polymerizable vinyl or olefinic group, such as allyl phosphate, mono- or diphosphate of bis(hydroxy-methyl)fumarate or itaconate, derivatives of (meth)acrylic acid esters, such as, for examples phosphates of hydroxyalkyl(meth)acrylates including 2-hydroxyethyl(meth)acrylate, 3-hydroxypropyl(meth)acrylates, and the like. One suitable P-acid monomer is 2-(methacroyloxy)ethyl phosphonic acid.

Preferably, the P-acid monomer is a phosphoric acid monoester of a vinyl-containing alcohol.

Preferably, the amount of polymerized units of monomer (M1) in polymer (P) is, by weight based on the dry weight of polymer (P), 0.5% or more; more preferably 1.0% or more; more preferably 1.5% or more. Preferably, the amount of polymerized units of monomer (M1) in polymer (P) is, by weight based on the dry weight of polymer (P), 10% or less; more preferably 7% or less; more preferably 5% or less.

Preferred monomer (M1) has structure (II) defined herein above. Preferably, Monomer (M1) has —R⁵ of structure (III)

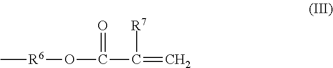

where R⁷ is hydrogen or methyl, and R⁶ is an alkyl group. Preferably, R⁶ has 1 to 8 carbon atoms; more preferably 2 to 4 carbon atoms; more preferably 2 carbon atoms. A monomer having structure (II) where R⁵ has structure (III) is known herein as a phosphoric acid monoester of a hydroxy-alkyl ester of (meth)acrylic acid.

Preferably, polymer (P) contains polymerized units of one or more monomer (“monomer (M2)”) other than monomer (M1). Preferably, monomer (M2) contains one or more vinyl monomer; more preferably, every monomer M2a is a vinyl monomer. Preferably, monomer (M2) contains one or more monomer selected from (meth)acrylic acid; substituted or unsubstituted alkyl esters of (meth)acrylic acid; (meth)acrylamide; N-substituted (meth)acrylamides; vinyl acetate; ethylene; styrene, alpha-alkyl substituted styrenes, butadiene, sodium styrene sulfonate, and mixtures thereof. More preferably, monomer (M2) contains one or more monomer selected from (meth)acrylic acid, unsubstituted alkyl esters of (meth)acrylic acid, sodium styrene sulfonate, and mixtures thereof.

Preferably, the sum of the polymerized units of monomer (M1) and (meth)acrylic acid is, by weight based on the dry weight of polymer (P), 1.5% or more. Preferably, the sum of the polymerized units of monomer (M1) and (meth)acrylic acid is, by weight based on the dry weight of polymer (P), 10% or less; more preferably 6% or less. Preferably, polymer (P) does not contain any polymerized units of any acid functional monomer other than monomer (M1) and (meth)acrylic acid.

Preferably, polymer (P) is an acrylic polymer. Preferably, polymer (P) contains polymerized units of an unsubstituted alkyl ester of acrylic acid, in an amount of, by weight based on the dry weight of polymer (P), 10% or more; more preferably 20% or more. Preferably, polymer (P) contains polymerized units of an unsubstituted alkyl ester of acrylic acid, in an amount of, by weight based on the dry weight of polymer (P), 80% or less; more preferably 70% or less. A preferred unsubstituted alkyl ester of acrylic acid is n-butyl acrylate. Preferably, the amount of polymerized units in polymer (P) selected from acrylic monomers, vinylaromatic monomers, and mixtures thereof is, by weight based on the dry weight of polymer (P), 75% or more; more preferably 85% or more; more preferably 95% or more.

Preferably, polymer (P) is formed by a polymerization process that is conducted in the absence of titanium dioxide.

Preferably, polymer (P) had glass transition temperature of −50° C. or higher; more preferably −40° C. or higher; more preferably −30° C. or higher; more preferably −10° C. or higher. Preferably, polymer (P) had glass transition temperature of 120° C. or lower; more preferably 105° C. or lower; more preferably 80° C. or lower; more preferably 50° C. or lower; more preferably 30° C. or lower.

Preferably, polymer (P) has Mw of 50,000 or higher.

Preferably, polymer (P) is produced by aqueous emulsion polymerization. Preferably, the aqueous emulsion polymerization is conducted using one or more anionic surfactant. Preferably, the aqueous emulsion polymerization is conducted using one or more water-soluble initiator; preferably, the solubility of the initiator in water is 1% or more by weight based on the weight of water.

The present invention involves the use of particles of sulfate-process titanium dioxide. Preferred is rutile titanium dioxide. Preferably the titanium dioxide particles have median particle size by weight of 0.2 micrometer or more. Preferably the titanium dioxide particles have median particle size by weight of 0.5 micrometer or less.

In some embodiments, particles of chloride-process titanium dioxide may be present in the composition as well as particles of sulfate-process titanium dioxide. If particles of chloride-process titanium dioxide are present, polymeric particles may or may not be adsorbed onto the surface thereof in the same manner as polymeric particles are adsorbed onto the surface of the sulfate-process titanium dioxide particles. If particles of chloride-process titanium dioxide are present, they are preferably dispersed in the same medium as the particles of sulfate-process titanium dioxide.

The titanium dioxide particles may optionally have at least one coating of one or more of silica, alumina, zinc oxide, and zirconia. For example, in certain embodiments titanium dioxide particles suitable for use in coatings of the present invention may have a coating of silica and a coating of alumina.

The present invention involves providing an aqueous dispersion (“dispersion (Db)”) of particles of sulfate-process titanium dioxide. Preferably, dispersion (Db) contains one or more water soluble polyelectrolyte dispersant. Polyelectrolyte dispersants are polymers that include polymerized units of one or more carboxyl-functional monomer. Polyelectrolyte dispersants include homopolymers of carboxyl-functional monomers, copolymers of more than one carboxyl-functional monomer, copolymers of one or more carboxyl functional monomer with one or more other monomer, and mixtures thereof. Also included in the category of polyelectrolyte dispersants are hydrophobically modified versions of such polymers.

Preferably, the amount of polyelectrolyte dispersant, by weight based on the dry weight of titanium dioxide, is 0.2% or more; more preferably 0.5% or more. Preferably, the amount of polyelectrolyte dispersant, by weight based on the dry weight of titanium dioxide, is 8% or less; more preferably 5% or less.

Preferably, the median particle size of the particles of polymer (P) is 70 nm or greater; more preferably 80 nm or greater; more preferably 90 nm or greater. Preferably the median particle size of the particles of polymer (P) is 300 nm or less; more preferably 200 nm or less; more preferably 150 nm or less. Preferably, the ratio of the median particle size of the particles of polymer (P) to the median particle size of the particles of titanium dioxide is 4:1 or less; more preferably 2:1 or less.

Preferably, the mixture is made under conditions that discourage gross coagulation of the mixture. Conditions used for making compositions in which polymer particles are adsorbed onto titanium dioxide particles are discussed, for example, in U.S. Pat. No. 6,080,802.

Preferably, some or all of the polymer particles that are adsorbed onto the titanium dioxide particles are adsorbed irreversibly. Preferably, at least half of the titanium dioxide particles are surface-saturated with polymer particles. A particle of titanium dioxide is surface-saturated with polymer particles if a sufficient number of polymer particles are adsorbed on the surface of the particle of titanium dioxide so that there is not room for any further polymer particles to adsorb.

The composition of the present invention may be a “grind” or may be a coating formulation. A grind contains 20% or more titanium dioxide by weight based on the weight of the grind; also, a grind contains neither coalescent nor binder polymer that is different from polymer (P). Preferably, a grind contains one or more dispersant.

Preferably, when a grind is made, making the grind includes making a mixture that includes water, polymeric particles of polymer (P), and particles of sulfate-process titanium dioxide. Preferably the volume ratio of particles of polymer (P) to particles of sulfate-process titanium dioxide is 1:1 or greater; more preferably 2:1 or greater; more preferably 2.5:1 or greater. Preferably the volume ratio of particles of polymer (P) to particles of sulfate-process titanium dioxide is 15:1 or less; more preferably 10:1 or less; more preferably 7:1 or less.

A coating formulation is suitable for application to a substrate to form a coating. A coating formulation preferably contains one or more coalescent. A coating formulation preferably contains one or more thickener. The total amount of titanium dioxide and other pigments in a coating formulation is characterized by the pigment volume concentration (PVC). In a coating formulation, preferred PVC is 1% or more; more preferably 3% or more; more preferably 10% or more. In a coating formulation, preferred PVC is 70% or less. For semi-gloss coating formulations, preferred PVC is 30% or less.

The following are examples of the present invention.

The pigments used in the examples were as follows:

| Material | Chemical | Process | Supplier |
|---|---|---|---|
| Ti-Pure ™ R- | Titanium dioxide | Chloride | E. I. DuPont Nemours |
| 902+ | | | and Company |
| NTR-606 | Titanium dioxide | sulfate | Ningbo Xinfu Titanium |
| | | | Dioxide Co. Ltd. |
| BLR-601 | Titanium dioxide | sulfate | Henan Billions Chemical |
| | | | Co. Ltd. |
| R-258 | Titanium dioxide | sulfate | Sichuan Pangang Group |
| | | | Co. Ltd. |
| Ropaque ™ | Polystyrene | | Dow Chemical Company |
| Ultra E | hollow particles | | |
| pigment | | | |

Monomers used were n-butyl acrylate (BA), styrene (ST), acrylic acid (AA), methacrylic acid (MAA), and phosphoethyl methacrylate (PEM; 65% active by weight). Further ingredients used in the Examples were as follows:

| Material | Chemical | Supplier |
|---|---|---|
| Primal ™ SF-055 Binder | Poly(styrene-acrylate) | Dow Chemical Co. |
| DirtShield ™ 12 Binder | Polyacrylate | Dow Chemical Co. |
| Polymer 1 | note (1) | |
| Polymer 2 | note (2) | |
| Rocima ™ 361 Biocide | | Dow Chemical Co. |
| Kathon ™ LXE Biocide | | Dow Chemical Co. |
| Acrysol ™ RM-2020 | Associative Thickener | Dow Chemical Co. |
| NPR Thickener | | |
| Primal ™ SCT-275 | Associative Thickener | Dow Chemical Co. |
| Thickener | | |
| NatrosolTM 250 HBR | Hydrophobic modified | Aqualon |
| Thickener | cellulose | |
| Propylene Glycol | Propylene glycol | |
| Coalescent | | |
| Texanol ™ Coalescent | 2,2,4-Trimethyl-1,3- | Eastman Chemical |
| | pentanediolmono(2- | Co. |
| | methylpropanoate | |
| COASOL ™ Coalescent | | Dow Chemical Co. |

note (1):
Aqueous acrylic latex polymer prepared according to the methods taught in US 2012/0058277;
solids: 43.5%
median particle size: 105 nm
polymerized units, parts by weight (based on 100 parts for the dry polymer): 58.5 BA/37.2 ST/2.3 PEM/2.0 AA
note (2):
Aqueous acrylic latex polymer prepared according to the methods taught in US 2012/0058277;
solids: 45.5%
median particle size: 100 nm
polymerized units, parts by weight (based on 100 parts for the dry polymer): 35.5 BA/61.5 MMA/2.0 PEM/1.0 MAA

Further ingredients used in the Examples were as follows:

| Material | Chemical | Supplier |
|---|---|---|
| AMP-95 Base | 2-methyl-2-amino-propanol | Dow Chemical Co. |
| Orotan ™ 1288 | polyacid | Dow Chemical Co. |
| Dispersant | | |
| Orotan ™ 731A | Hydrophobic modified | Dow Chemical Co. |
| Dispersant | polyacid Copolymer | |
| Triton ™ BD-405 | Nonionic surfactant | Dow Chemical Co. |
| Surfactant | | |
| Triton ™ EF-106 | Nonionic surfactant | Dow Chemical Co. |
| Surfactant | | |
| BYK 022 Defoamer | Polyether siloxane copolymer | BYK. |

### COMPARATIVE EXAMPLES 1-C-1 AND 1-C-2

Comparative Examples 1-C-1 and 1-C-2 are typical flat white paint formulations. For each formulation, first, a “grind” was made using the ingredients shown, blended in a high-shear mixer. Amounts shown are in parts by weight (pbw).

| Grind | 1-C-1 | 1-C-2 |
|---|---|---|
| Ingredient | pbw | pbw |
| Water | 362.2 | 362.2 |
| Natrosol 250 HBR | 6.0 | 6.0 |
| AMP-95 | 1.0 | 1.0 |
| Orotan 1288 | 4.5 | 4.5 |
| Foamaster NXZ | 0.5 | 0.5 |
| NTR-606 | 139.8 | 118.8 |
| clay | 110.0 | 117.5 |
| Talc | 59.0 | 64.2 |
| CaCO3 | 90.0 | 96.3 |

Then the complete contents of the grind were mixed with the “let down” ingredients by ordinary stiffing.

| LetDown | 1-C-1 | 1-C-2 |
|---|---|---|
| Ingredient | pbw | pbw |
| Water | 23.3 | 25.3 |
| Ethylene Glycol | 9.0 | 9.0 |
| Tergitol 15-S-40(30%) | 2.0 | 2.0 |
| Ropaque Ultra E | 20.2 | 20.2 |
| Primal ™ SF-055 | 161.4 | 161.4 |
| Foamstar A 10 | 4.0 | 4.0 |
| Texanol ™ | 7.1 | 7.1 |

The properties of Comparative Examples 1-C-1 and 1-C-2 were as follows. PVC is pigment volume concentration.

| Property | 1-C-1 | 1-C-2 |
|---|---|---|
| Total PVC (%) | 67.2 | 67.2 |
| Volume Solids (%) | 29.4 | 29.4 |

### EXAMPLE 1

Example 1 is a flat white paint formulation, having the same PVC and volume solids as Comparative Examples 1C-1 and 1C-2; also, Example 1 has the same amount of titanium dioxide as Comparative Example 1C-2. First, a “premix” was made using high shear mixing:

| Premix | |
|---|---|
| Ingredient | parts by weight |
| Water | 66.5 |
| Orotan 1288 | 2.0 |
| Foamaster NXZ | 0.5 |
| NTR-606 | 118.8 |
| Polymer 1 | 154.0 |

Separately, a grind was made using high shear mixing:

| Grind | |
|---|---|
| Ingredient | parts by weight |
| Water | 292.9 |
| Natrosol 250 HBR | 5.0 |
| AMP-95 | 1.0 |
| Orotan 1288 | 2.6 |
| Foamaster NXZ | 0.5 |
| Clay | 117.5 |
| Talc | 64.2 |
| CaCO3 | 96.3 |

The complete Grind and the complete Pre-Mix were mixed together with the following Let Down ingredients by normal agitation:

| LetDown | |
|---|---|
| Ingredient | parts by weight |
| Water | 17.9 |
| Ethylene Glycol | 9.0 |
| Tergitol 15-S-40(30%) | 2.0 |
| Ropaque Ultra E | 20.2 |
| Primal ™ SF-055 | 18.0 |
| Foamstar A 10 | 4.0 |
| Texanol ™ | 7.1 |

The properties of Example 1 were as follows:

| Property | Value (%) |
|---|---|
| Total PVC | 67.2 |
| Volume Solids | 29.4 |

### COMPARATIVE EXAMPLE 2-C

Example 2-C is a typical semi-gloss white paint formulation. Grind and Let Down were made and blended as in Comparative Example 1-C-1

| Ingredient | parts by weight |
|---|---|
| Grind | |
| Water | 29.7 |
| Orotan 731A | 3.0 |
| BYK-022 | 0.5 |
| TiO2 | 100.0 |
| LetDown | |
| DirtShield 12 | 253.5 |
| Propylene Glycol | 11.0 |
| BYK-022 | 0.4 |
| Triton BD-405 | 1.0 |
| Triton EF-106 | 1.0 |
| Ropaque Ultra E | 20.0 |
| Kathon LXE | 0.5 |
| Rocima 361 | 3.5 |
| COASOL | 23.4 |
| Acrysol RM-2020 NPR | 4.2 |
| Water | 47.2 |
| Primal SCT-275 | 1.3 |
| AMP-95 | 0.2 |

| Property | Value (%) |
|---|---|
| Total PVC | 24.1 |
| Volume Solids | 35.3 |

### EXAMPLE 2

Example 2 is a semi-gloss white paint formulation having PVC and volume solids the same as Comparative Example 2-C. Premix was made using high shear and then mixed with the Let Down ingredients with normal mixing agitation.

| Premix | |
|---|---|
| Ingredient | parts by weight |
| Water | 26.8 |
| Orotan 731A | 2.7 |
| BYK-022 | 0.5 |
| TiO2 | 90.0 |
| Water | 23.4 |
| Polymer 2 | 120.0 |

| LetDown | |
|---|---|
| Ingredients | parts by weight |
| DirtShield 12 | 147.5 |
| Propylene Glycol | 11.0 |
| BYK-022 | 0.5 |
| Triton BD-405 | 1.0 |
| Triton EF-106 | 1.0 |
| Ropaque Ultra E | 26.5 |
| Kathon LXE | 0.5 |
| Rocima 361 | 3.5 |
| COASOL | 24.1 |
| Acrysol RM-2020 NPR | 4.0 |
| Water | 15.8 |
| AMP-95 | 0.2 |
| Primal SCT-275 | 1.4 |

| Property | Value (%) |
|---|---|
| Total PVC | 24.2 |
| Volume Solids | 35.3 |

Three versions of Example 2 and comparative Example 2-C were made, as follows:

| Versions of Example 2 | Versions of Comparative 2-C | TiO₂ type |
|---|---|---|
| 2-a | 2-C-a | NTR-606 |
| 2-b | 2-C-b | BLR-601 |
| 2-c | 2-C-c | R-258 |

### EXAMPLES 3-C-1, 3, AND 3-C-2

Examples 3-C-1 and 3-C-2 are comparative.

### Ingredients: Parts by Weight

| Example: | 3-C-1-a | 3-a | 3-C-2-a |
|---|---|---|---|
| Grind | | | |
| Water | 60.00 | 60.00 | 50.00 |
| Orotan 731A | 6.00 | 6.00 | 5.10 |
| BYK-022 | 1.00 | 1.00 | 1.00 |
| titanium dioxide | 200.00 | 170.00 | 169.99 |
| Water | | | 44.06 |
| Polymer 2 | | | 225.97 |
| Let Down | | | |
| DirtShield 12 | 506.00 | 506.00 | 300.22 |
| Propylene Glycol | 22.00 | 22.00 | 22.01 |
| BYK-022 | 1.00 | 1.00 | 1.00 |
| Triton BD-405 | 2.00 | 2.00 | 2.00 |
| Triton EF-106 | 2.00 | 2.00 | 2.00 |
| Ropaque Ultra E | 40.00 | 55.00 | 55.00 |
| Kathon LXE | 1.00 | 1.00 | 1.00 |
| Rocima 361 | 7.00 | 7.00 | 7.00 |
| COASOL | 46.79 | 47.60 | 47.60 |
| Acrysol RM-2020 NPR | 8.43 | 8.43 | 8.10 |
| Water | 93.77 | 85.50 | 33.50 |
| AMP-95 | | | 0.36 |
| Primal SCT-275 | 2.70 | 2.70 | 2.72 |
| AMP-95 | 0.32 | 0.32 | |

Four more versions of these examples were made, in which R-902+ was replaced by various sulfate-process TiO₂ products, as follows:

| Versions of | Versions of | Versions of | TiO₂ |
|---|---|---|---|
| Comparative 3-C-1 | Example 3 | Comparative 3-C-2 | type |
| 3-C-1-a | 3-a | 3-C-2-a | R-902+ |
| 3-C-1-b | 3-b | 3-C-2-b | R-996 |
| 3-C-1-c | 3-c | 3-C-2-c | NTR-606 |
| 3-C-1-d | 3-d | 3-C-2-d | R-258 |
| 3-C-1-e | 3-e | 3-C-2-e | BLR-601 |

In each case, the “3-C-1” comparative is designed to have similar hiding and whiteness as the corresponding “3” Example. For instance, when comparing Comparative 3-C-1-b to Example 3-b, it is expected that hiding (contrast ratio “C”) and whiteness (measurement “L”) will be similar to each other, and the comparison will demonstrate whether 3-b shows better yellowness (measurement “b”).

The “3-C-1” comparatives have lower level of titanium dioxide than the “3” examples, because the “3” examples achieve good hiding with less titanium dioxide.

Comparison with the “3-C-2” comparative is designed to make a comparison with a fixed amount of titanium dioxide, regardless of other factors. For instance, comparing Comparative 3-C-2-b with Example 3-b will show whether 3-b shows better yellowness than a corresponding comparative that has the same amount of titanium dioxide.

### EXAMPLE 4

### Test Results

Contrast ratio test was as follows. Drawdowns of paints were made with 100 μm film applicator, to give wet film thickness of 100 μm, on a 5C opacity chart and allowed to dry for 1 and/or 7 days in the controlled temperature room (“CTR”; 25° C., 50% relative humidity). The Y-reflectance was measured in three areas over both the white and black areas of the 5C opacity chart. Contrast “C” is reported as a percentage:

C=100×(average reflectance over black)/(average reflectance over white).

A paint with poor hiding gives low values of C, and a paint with perfect hiding would give C of 100%.

Scattering coefficient was measured as follows. Using a Bird-style drawdown bar to give 38 μm thick wet coating, films were cast on black release charts. Also, using a drawdown block (wet film thickness 625 μm) on a black vinyl scrub chart, thick films were cast. All films were dried overnight in CT. A glass projector slide cover was placed on thin film and scored with a sharp blade to obtain the test area. (84 cm²). 5 reflectance values on the scored thin film test area were measured, and the average value was recorded. Also, 5 reflectance values on the scored thick film test area were measured, and the average value was recorded. Each film was carefully removed from the substrate and weighed. From measured reflectance values of thick and thin film and the weight of film test area, calculate hiding “S” values were calculated as follows:

$$S = {X}^{- 1} [ \frac{R}{1 - {R}^{2}} ] ln \{ ( 1 - {R}_{B} R ) / ( 1 - \frac{{R}_{B}}{R} ) \}$$

where X=average film thickness (found from the density, area, and weight of the film)
R=average reflectance of the thick film
R_{B}=average reflectance of the thin film
   S is reported in units of number per 25.4 μm; this is referred to herein as “S/mil”

Paint was applied with a film applicator to give wet paint film of thickness 150 μm and was allowed to dry for 1 day and/or 7 days in the controlled temperature room (“CTR”; 25° C., 50% relative humidity) To evaluate the whiteness and yellow color phase, L/a/b values of the Lab Color Space were also measured on the white area of the 5C opacity chart. The “b” value is considered to evaluate the yellowness of the coating; lower values of b correspond to less yellow color in the coating. The “L” value is considered to evaluate the overall brightness of the coating; higher L values correspond to brighter coatings.

On the same dried films, the Y reflectance of the CIE tristimulus values was also measured, on the white area of the 5C opacity chart.

Results were as follows:

| | 1-C-1 | 1-C-2 | Example 1 |
|---|---|---|---|
| Contrast Ratio (C) | 95.50% | 95.27 | 95.48% |
| L | 96.22 | 96.15 | 96.16 |
| a | −0.47 | −0.45 | −0.45 |
| b | 1.55 | 1.58 | 1.48 |

Comparative 1-C-1 was designed to have similar hiding to Example 1, and Comparative 1-C-2 was designed to have the same amount of titanium dioxide as Example 1. Compared with Comparative 1-C-2, the Example 1 shows improved hiding (C %), equal brightness (L), equal reflectance (Y) and improved yellowness (lower b). Compared with Comparative 1-C-1, Example 1 shows equal hiding (C %), similar brightness (L) and improved yellowness (lower b).

| | Comparative 1-C | Example 1 |
|---|---|---|
| Contrast Ratio (C) | 96.0% | 95.6% |
| L | 96.9 | 95.9 |
| a | −0.47 | −0.43 |
| b | 1.15 | 1.08 |

Example 1 shows equivalent hiding and brightness with improved yellow color.

| Test | 2-C-a | 2-a | 2-C-b | 2-b | 2-C-c | 2-c |
|---|---|---|---|---|---|---|
| S/mil | 6.7 | 7.3 | 5.8 | 6.6 | 6.6 | 7.2 |
| L | 98.2 | 98.3 | 97.9 | 97.9 | 97.8 | 98.0 |
| a | −0.6 | −0.6 | −0.6 | −0.6 | −0.5 | −0.5 |
| b | 1.8 | 1.6 | 2.2 | 1.8 | 2.0 | 1.8 |

When each of the Examples is compared to its corresponding Comparative Example (e.g., when 2-a is compared with 2-C-a), the Example shows improved scattering coefficient (S/mil), equivalent or improved brightness (L), and improved yellowness (b).

| | 3-C- | 3-C- | | 3-C- | 3-C- | | 3-C- | 3-C- | |
|---|---|---|---|---|---|---|---|---|---|
| | 1-a | 2-a | 3-a | 1-b | 2-b | 3-b | 1-b | 2-b | 3-b |
| L | 97.00 | 96.87 | 97.14 | 96.54 | 96.46 | 96.84 | 96.85 | 96.69 | 96.98 |
| a | −0.49 | −0.47 | −0.45 | −0.53 | −0.51 | −0.48 | −0.55 | −0.52 | −0.50 |
| b | 0.93 | 0.95 | 0.77 | 1.39 | 1.37 | 1.05 | 1.17 | 1.15 | 0.90 |
| C % | 95.83 | 95.94 | 96.31 | 95.81 | 95.44 | 96.29 | 95.92 | 95.65 | 96.60 |
| Y | 92.43 | 92.11 | 92.78 | 91.31 | 91.12 | 92.05 | 92.08 | 91.67 | 92.39 |

| | 3-C- | 3-C- | | 3-C- | 3-C- | |
|---|---|---|---|---|---|---|
| | 1-d | 2-d | 3-d | 1-e | 2-e | 3-e |
| L | 96.58 | 96.48 | 96.78 | 96.72 | 96.54 | 96.93 |
| a | −0.56 | −0.56 | −0.53 | −0.53 | −0.51 | −0.49 |
| b | 1.40 | 1.40 | 1.11 | 1.39 | 1.34 | 1.12 |
| C % | 95.56 | 94.77 | 95.95 | 96.15 | 95.42 | 96.45 |
| Y | 91.37 | 91.15 | 91.91 | 91.77 | 91.31 | 92.26 |

The trends in the results for Example 3 can be seen, for example in the following comparisons. When Example 3-b is compared to Comparative 3-C-1-b, it can be seen that the two coatings have similar hiding effectiveness. This is demonstrated by the fact that 3-b has comparable and slightly better results for contrast ratio (C), whiteness (L), and reflectance (Y). Also, 3-b has much lower yellowness, as seen by the lower values of the “b” measurement. Thus, compared to the corresponding comparative, 3-b demonstrates improvement in yellowness when hiding effectiveness is kept roughly constant.

When Example 3-b is compared to Comparative 3-C-2-b, it can be seen that when the amount of titanium dioxide is kept constant, 3-b still shows some improvement in hiding effectiveness and a strong improvement in reducing yellowness.

These effects are the same when examples 3-a, 3-c, 3-d, and 3-e are compared to the corresponding comparatives.

1. An aqueous composition comprising a dispersion of particles of sulfate-process titanium dioxide, wherein polymeric particles are adsorbed onto said particles of titanium dioxide, wherein said polymeric particles comprise polymerized units of one or more P-acid monomer.

2. The aqueous composition of claim 1, wherein said P-acid monomer is a phosphoric acid monoester of a hydroxy-alkyl ester of (meth)acrylic acid.

3. The aqueous composition of claim 1 wherein the amount of said polymerized units of one or more P-acid monomer is 0.5% to 5% by weight based on the dry weight of said polymeric latex particles.

4. The aqueous composition of claim 1, wherein said polymeric particles are polymerized in the absence of titanium dioxide particles.

5. The aqueous composition of claim 1, wherein said polymeric particles are formed by aqueous emulsion polymerization.

6. The aqueous composition of claim 1, wherein said polymeric particles have median particle size of 80 to 200 nm.

7. The aqueous composition of claim 1, wherein said aqueous dispersion is a coatings formulation, and wherein the PVC of said coatings formulation is 10-70%.

8. The aqueous dispersion of claim 1, wherein said aqueous dispersion further comprises a dispersion of particles of chloride-process titanium dioxide.

9. An aqueous dispersion,
wherein said aqueous dispersion is a grind made by a process comprising making a mixture that comprises water, polymeric particles, and particles of sulfate-process titanium dioxide,
wherein said polymeric particles comprise polymerized units of one or more P-acid monomer, and
wherein the volume ratio of said polymeric particles to said particles of sulfate-process titanium dioxide is 2.5:1 to 10:1.
